(19) United States
(12) Patent Application Publication
(10) Pub. No.: US 2021/0268835 A1
(43) Pub. Date: Sep. 2, 2021

(54) VEHICLE WHEEL RESONATOR AND VEHICLE WHEEL

(71) Applicant: HONDA MOTOR CO., LTD., Tokyo (JP)

(72) Inventor: Youichi KAMIYAMA, Tokyo (JP)

(21) Appl. No.: 17/181,074

(22) Filed: Feb. 22, 2021

(30) Foreign Application Priority Data
Feb. 28, 2020 (CN) 202010133548.9

(51) Int. Cl. B60B 21/12; B60C 19/00; B60B 21/02

(52) U.S. Cl. CPC B60B 21/12; B60C 19/002; G10K 11/172; B60B 2900/133; B60B 21/02

(57) ABSTRACT

A vehicle wheel resonator includes: a resonator main body which is mounted on a vehicle wheel in a tire air chamber between the vehicle wheel and a tire, to define a sub-air chamber; and a communication hole through which the sub-air chamber communicates with the tire air chamber. The communication hole has a first cross-sectional area having a first channel cross-sectional area and a second cross-sectional area having a second channel cross-sectional area. The first channel cross-sectional area is smaller than the second channel cross-sectional area.

### CROSS-REFERENCE TO RELATED APPLICATION

The present application claims the benefit of priority to Chinese Patent Application No. 202010133548.9 filed on Feb. 28, 2020, the disclosures of all of which are hereby incorporated by reference in their entireties.

### TECHNICAL FIELD

The present disclosure relates to a vehicle wheel resonator and a vehicle wheel.

### BACKGROUND

There has been a vehicle wheel including a Helmholtz resonator which extends in a circumferential direction of the wheel on an outer surface of a well of a rim, to cancel air column resonance of a tire (see Japanese Patent No. JP6541769, for example).

### SUMMARY

In the Helmholtz resonator, the higher viscous resistance to air is at communication holes, the better an attenuation effect on resonance is. Then, it is conceivable to increase the attenuation effect on the resonance by reducing an inner diameter of the communication holes so as to increase the viscous resistance to air at the communication holes.

However, when the inner diameter of the communication hole is reduced in size, there may be a difference between a channel cross-sectional area of the communication hole in design and a channel cross-sectional area of a molded product, caused by variation in thickness, due to mass production, of a communication hole forming part of the Helmholtz resonator. If the channel cross-sectional area of the communication hole, which is used as a parameter of a calculation formula for resonance frequency, fails to be a specified value, the Helmholtz resonator does not exert expected performance.

An aspect of the present disclosure is to provide a vehicle wheel resonator and a vehicle wheel which reduce a difference between a channel cross-sectional area of a communication hole in design and a channel cross-sectional area of a molded product, caused by variation in thickness of a communication hole forming part, and have a superior attenuation effect on resonance.

A vehicle wheel resonator of the present disclosure to solve the problems above includes: a resonator main body which is mounted on a vehicle wheel in a tire air chamber between the vehicle wheel and a tire, to define a sub-air chamber; and a communication hole through which the sub-air chamber communicates with the tire air chamber, wherein the communication hole has a first cross-sectional area having a first channel cross-sectional area and a second cross-sectional area having a second channel cross-sectional area, and the first channel cross-sectional area is smaller than the second channel cross-sectional area.

Further, a vehicle wheel of the present disclosure includes the vehicle wheel resonator described above.

According to the present disclosure, a vehicle wheel resonator and a vehicle wheel are provided, which reduce a difference between a channel cross-sectional area of a communication hole in design and a channel cross-sectional area of a molded product, caused by variation in thickness of a communication hole forming part, and have a superior attenuation effect on resonance.

### BRIEF DESCRIPTION OF THE DRAWINGS

FIG. 1 is a partially enlarged perspective view of a vehicle wheel according to an embodiment of the present disclosure, including a Helmholtz resonator mounted on an outer circumferential surface of a well;

FIG. 2 is a cross-sectional view of the vehicle wheel taken along a line II-II in FIG. 1;

FIG. 3 is a perspective view of the entire Helmholtz resonator;

FIG. 4 is a partially enlarged perspective view of the Helmholtz resonator as viewed from an arrow direction IV in FIG. 1;

FIG. 5 is a cross-sectional view taken along a line V-V in FIG. 4;

FIG. 6A is a partially enlarged perspective view of the Helmholtz resonator including a cross section taken along a line VIA-VIA in FIG. 4;

FIG. 6B is a partially enlarged plan view of the Helmholtz resonator as viewed from an arrow direction VIB in FIG. 6A;

FIG. 6C is a partially enlarged bottom view of the Helmholtz resonator as viewed from an arrow direction VIC in FIG. 6A;

FIG. 7A is a displacement distribution diagram when a centrifugal force is applied to the Helmholtz resonator according to the embodiment of the present disclosure;

FIG. 7B is a displacement distribution diagram when a centrifugal force is applied to the Helmholtz resonator according to a comparative example;

FIG. 8A is a partially enlarged perspective view of a Helmholtz resonator according to a first modification;

FIG. 8B is a partially enlarged plan view of the Helmholtz resonator as viewed from an arrow direction VIIIB in FIG. 8A;

FIG. 8C is a partially enlarged bottom view of the Helmholtz resonator as viewed from an arrow direction VIIIC in FIG. 8A;

FIG. 9A is a partially enlarged perspective view of a Helmholtz resonator according to a second modification;

FIG. 9B is a partially enlarged plan view of the Helmholtz resonator as viewed from an arrow direction IXB in FIG. 9A;

FIG. 9C is a partially enlarged bottom view of the Helmholtz resonator as viewed from an arrow direction IXC in FIG. 9A;

FIG. 10A is a partially enlarged perspective view of a Helmholtz resonator according to a third modification;

FIG. 10B is a partially enlarged plan view of the Helmholtz resonator as viewed from an arrow direction XB in FIG. 10A;

FIG. 10C is a partially enlarged bottom view of the Helmholtz resonator as viewed from an arrow direction XC in FIG. 10A;

FIG. 11A is a partially enlarged perspective view of a Helmholtz resonator according to a fourth modification;

FIG. 11B is a partially enlarged plan view of the Helmholtz resonator as viewed from an arrow direction XIB in FIG. 11A;

FIG. 11C is a partially enlarged bottom view of the Helmholtz resonator as viewed from an arrow direction XIC in FIG. 11A;

FIG. 12A is a partially enlarged perspective view of a Helmholtz resonator according to a fifth modification;

FIG. 12B is a partially enlarged plan view of the Helmholtz resonator as viewed from an arrow direction XIIB in FIG. 12A;

FIG. 12C is a partially enlarged bottom view of the Helmholtz resonator as viewed from an arrow direction XIIC in FIG. 12A;

FIG. 13A is a partially enlarged perspective view of a Helmholtz resonator according to a sixth modification;

FIG. 13B is a partially enlarged plan view of the Helmholtz resonator as viewed from an arrow direction XIIIB in FIG. 13A;

FIG. 13C is a partially enlarged bottom view of the Helmholtz resonator as viewed from an arrow direction XIIIC in FIG. 13A;

FIG. 14A is a partially enlarged perspective view of a Helmholtz resonator according to a seventh modification;

FIG. 14B is a partially enlarged plan view of the Helmholtz resonator as viewed from an arrow direction XIVB in FIG. 14A;

FIG. 14C is a partially enlarged bottom view of the Helmholtz resonator as viewed from an arrow direction XIVC in FIG. 14A;

FIG. 15A is a partially enlarged perspective view of a Helmholtz resonator according to an eighth modification;

FIG. 15B is a partially enlarged plan view of the Helmholtz resonator as viewed from an arrow direction XVB in FIG. 15A;

FIG. 15C is a partially enlarged bottom view of the Helmholtz resonator as viewed from an arrow direction XVC in FIG. 15A;

FIG. 16A is a partially enlarged perspective view of a Helmholtz resonator according to a ninth modification;

FIG. 16B is a partially enlarged plan view of the Helmholtz resonator as viewed from an arrow direction XVIB in FIG. 16A;

FIG. 16C is a partially enlarged bottom view of the Helmholtz resonator as viewed from an arrow direction XVIC in FIG. 16A;

FIG. 17A is a partially enlarged perspective view of a Helmholtz resonator according to a tenth modification;

FIG. 17B is a partially enlarged plan view of the Helmholtz resonator as viewed from an arrow direction XVIIB in FIG. 17A;

FIG. 17C is a partially enlarged bottom view of the Helmholtz resonator as viewed from an arrow direction XVIIC in FIG. 17A;

FIG. 18A is a partially enlarged perspective view of a Helmholtz resonator according to an eleventh modification;

FIG. 18B is a partially enlarged plan view of the Helmholtz resonator as viewed from an arrow direction XVIIIB in FIG. 18A;

FIG. 18C is a partially enlarged bottom view of the Helmholtz resonator as viewed from an arrow direction XVIIIC in FIG. 18A;

FIG. 19A is a cross-sectional view of a communication hole in a Helmholtz resonator according to a twelfth modification along a circumferential direction of a wheel;

FIG. 19B is a cross-sectional view of a communication hole in a Helmholtz resonator according to a thirteenth modification along the circumferential direction of the wheel;

FIG. 19C is a cross-sectional view of a communication hole in a Helmholtz resonator according to a fourteenth modification along the circumferential direction of the wheel;

FIG. 19D is a cross-sectional view of a communication hole in a Helmholtz resonator according to a fifteenth modification along the circumferential direction of the wheel;

FIG. 20A is a partially enlarged plan view of the vicinity of the communication hole of a Helmholtz resonator according to a sixteenth modification;

FIG. 20B is a cross-sectional view taken along a line XXB-XXB in FIG. 20A; and

FIG. 21 is a cross-sectional view of the vehicle wheel including a Helmholtz resonator according to the seventeenth modification.

### DETAILED DESCRIPTION

Next, a description is given of an embodiment to implement the present disclosure in detail, with reference to the drawings as appropriate. Note that “X” indicates a circumferential direction of a wheel, “Y” indicates a width direction of the wheel, and “Z” indicates a radial direction of the wheel, respectively, in the drawings.

A vehicle wheel according to the present embodiment has a feature in which communication holes of a Helmholtz resonator each have a first cross-sectional area having a first channel cross-sectional area and a second cross-sectional area having a second channel cross-sectional area, and the first channel cross-sectional area is smaller than the second channel cross-sectional area. Note that the Helmholtz resonator in the following description corresponds to a “vehicle wheel resonator” in the appended claims.

Further, the “channel cross-sectional area” is a cross-sectional area perpendicular to a channel of the communication hole.

In the following description, an entire structure of the vehicle wheel is described, and then, the Helmholtz resonator (simply referred to as “resonator” hereinafter) is described.

### <Entire Structure of Vehicle Wheel>

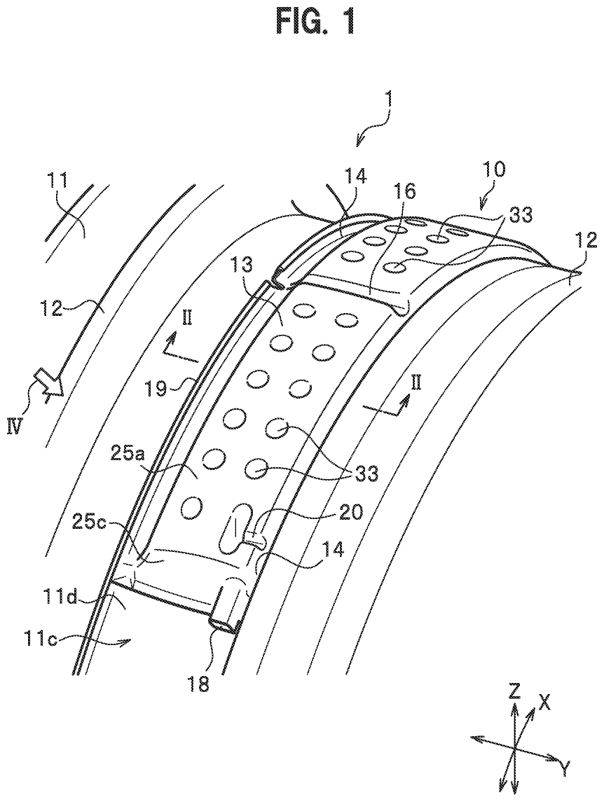

FIG. 1 is a partially enlarged perspective view of a vehicle wheel 1 according to the present embodiment, including a resonator 10 mounted on an outer circumferential surface 11d of a well 11c.

As shown in FIG. 1, the vehicle wheel 1 according to the present embodiment includes a resonator 10 made of a synthetic resin, such as polypropylene and polyamide, mounted on a rim 11 made of a metal, such as an aluminum alloy and a magnesium alloy. The rim 11 in the present embodiment is assumed to be a cast product, and the resonator 10 is assumed to be obtained by blow molding in which air is blown into a mold forming a communication hole part to be described below.

Note that, though not shown in FIG. 1, a disk coupling the rim 11 to a hub is arranged on a left side of a drawing paper in the width direction Y.

The rim 11 includes the well 11c recessed inward in the radial direction between bead sheets 12, formed at both ends in the width direction Y, respectively. The outer circumferential surface 11d of the well 11c defined by a bottom surface of the recess has substantially the same diameter about a wheel axis in the width direction Y.

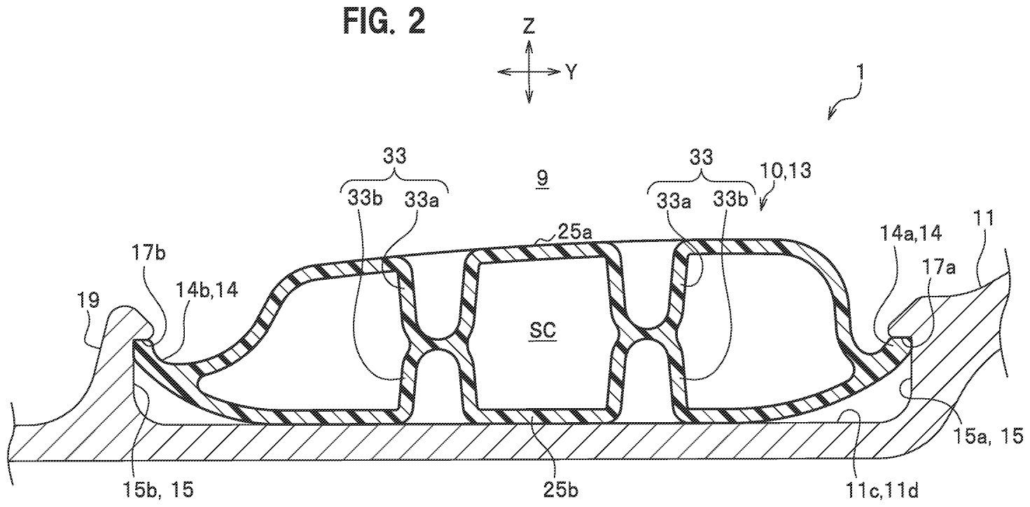

FIG. 2 is a cross-sectional view taken along a line II-II of the vehicle wheel 1 shown in FIG. 1.

As shown in FIG. 2, the rim 11 of the present embodiment includes a pair of vertical walls 15 facing each other in the width direction Y. The pair of vertical walls has a first vertical wall surface 15a and a second vertical wall surface 15b, respectively. The vertical wall surfaces 15a, 15b extend outward in the radial direction Z from the outer circumferential surface 11d, at a predetermined distance in the width direction Y therebetween.

The first vertical wall surface 15a on one side in the width direction Y is assumed to be formed at a rising part extending from the outer circumferential surface 11d of the well 11c toward a rim flange.

Further, the second vertical wall surface 15b on the other side is assumed to be formed by a circumferential wall extending in the circumferential direction X substantially at the middle in the width direction Y of the outer circumferential surface 11d. The vertical wall surfaces 15a, 15b extend annularly in the circumferential direction X, at a predetermined distance, to face each other.

The first vertical wall surface 15a is formed with a first groove 17a into which an end of an edge 14 (14a), to be described below, of the resonator 10 is fitted, and the second vertical wall surface 15b is formed with a second groove 17b into which an end of an edge 14 (14b), to be described below, of the resonator 10 is fitted. The grooves 17a, 17b extend in the circumferential direction X to form annular circumferential grooves.

### <Resonator>

Next, a description is given of the resonator 10.

As shown in FIG. 1, the resonator 10 is a member elongated extending in one direction and includes a main body 13, a communication hole 18, and the edge 14 through which the main body 13 is fixed on the rim 11. Note that the main body 13 corresponds to a “resonator main body” in the appended claims.

The resonator 10 as described above is symmetrical in the circumferential direction X with respect to a partition wall 16 extending in the width direction Y at the middle of the main body 13.

The main body 13 is curved in the longitudinal direction thereof. In other words, when the resonator 10 is mounted on the outer circumferential surface 11d (see FIG. 1) of the well 11c (see FIG. 1), the main body 13 follows along the circumferential direction X.

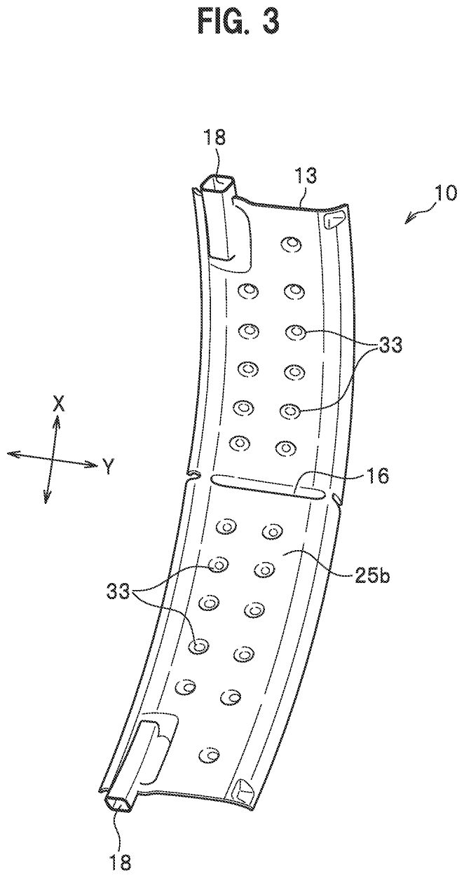

The main body 13 is hollow inside. A hollow portion (not shown) defines a sub-air chamber SC (see FIG. 2) to be described below. The hollow portion is divided into two in the circumferential direction X by the partition wall 16. Note that the partition wall 16 is formed by an upper surface 25a (see FIG. 1) and a lower surface 25b (see FIG. 3), to be described below, recessed in a groove shape along the width direction Y. Though not shown, the upper surface 25a and lower surface 25b are joined to each other substantially at the middle therebetween to form the partition wall 16.

As shown in FIG. 2, the main body 13 of the resonator 10 has a flat shape elongated in the width direction Y in a cross-sectional view orthogonal to the longitudinal direction (circumferential direction X in FIG. 1).

Specifically, the main body 13 is formed with the upper surface 25a and lower surface 25b.

The lower surface 25b is a plate formed along the outer circumferential surface 11d of the well 11c. That is, the lower surface 25b is formed to be substantially flat in the width direction Y so as to be curved, with substantially the same curvature as the outer circumferential surface 11d, in the circumferential direction X (see FIG. 1).

The upper surface 25a is a plate facing the lower surface 25b at a predetermined distance. The upper surface 25a is curved with a predetermined curvature in the circumferential direction X (see FIG. 1).

The sub-air chamber SC is defined between the upper surface 25a and lower surface 25b described above.

Further, as shown in FIG. 1, the main body 13 includes a lateral plate 25c to connect the upper surface 25a with the lower surface 25b at an end in the circumferential direction X.

Note that the resonator 10 of the present embodiment is symmetrical in the circumferential direction X with respect to the partition wall 16. Therefore, though not shown for convenience of drawing, the lateral plates 25c in the present embodiment are arranged to be symmetrical with each other for pairing, at both ends in the longitudinal direction (circumferential direction X) of the main body 13.

FIG. 3 is a perspective view of the entire resonator 10 as viewed from an inner surface (lower surface 25b).

As shown in FIG. 3, the main body 13 is formed to have a plurality of cylindrical parts 33 arranged at equal intervals in the circumferential direction X. Further, the cylindrical parts 33 are arranged in two rows in the width direction Y.

Returning to FIG. 2, each cylindrical part 33 is formed by an upper joint 33a and a lower joint 33b joined with each other substantially at the middle between the upper surface 25a and lower surface 25b.

Note that the upper joint 33a is formed by the upper surface 25a partially recessed toward the lower surface 25b. Further, the lower joint 33b is formed by the lower surface 25b partially recessed toward the upper surface 25a.

The cylindrical part 33 described above has a substantially cylindrical shape in which the upper surface 25a is partially joined with the lower surface 25b. As shown in FIGS. 1 and 3, the cylindrical parts 33 define circular openings in a plan view at respective corresponding positions of the upper surface 25a and lower surface 25b in an up/down direction of the main body 13.

Next, a description is given of the edge 14 (see FIG. 2).

As shown in FIG. 2, the edge 14 has the edge 14a extending from the main body 13 toward the first vertical wall surface 15a and the edge 14b extending from the main body 13 toward the second vertical wall surface 15b.

In the present embodiment, the edge 14b is longer than the edge 14a.

Each of the edges 14a and 14b forms, with the lower surface 25b, a curved surface protruding toward the outer circumferential surface 11d of the well 11c. A thickness or a material of the edges 14a and 14b is appropriately selected to have spring elasticity.

An end of the edge 14a described above is fitted into the groove 17a of the first vertical wall surface 15a. Further, an end of the edge 14b is fitted into the groove 17b of the second vertical wall surface 15b.

Next, a description is given of the communication hole 18 (see FIG. 1).

As shown in FIG. 1, the communication hole 18 is arranged at an end in the circumferential direction X, and at one end in the width direction Y, of the main body 13. Specifically, the communication hole 18 is arranged at an opposite end to the disk in the width direction Y.

The communication hole 18 is defined by a tubular body protruding from the main body 13 in the circumferential direction X, communicates with the sub-air chamber SC (see FIG. 2) at one end of the tubular body, and is open at the other end extending from the main body 13.

Accordingly, the communication hole 18 allows the sub-air chamber SC (see FIG. 2) to communicate with a tire air chamber 9 (see FIG. 2).

As described above, the resonator 10 of the present embodiment has a symmetrical shape in the circumferential direction X with respect to the partition wall 16. Therefore, as shown in FIG. 3, the communication holes 18 of the present embodiment are arranged to be paired at positions symmetrical with each other, respectively, at both ends in the longitudinal direction (circumferential direction X) of the main body 13. The pair of communication holes 18 of the present embodiment are arranged at positions separated apart at an angle of substantially 90 degrees about the wheel shaft.

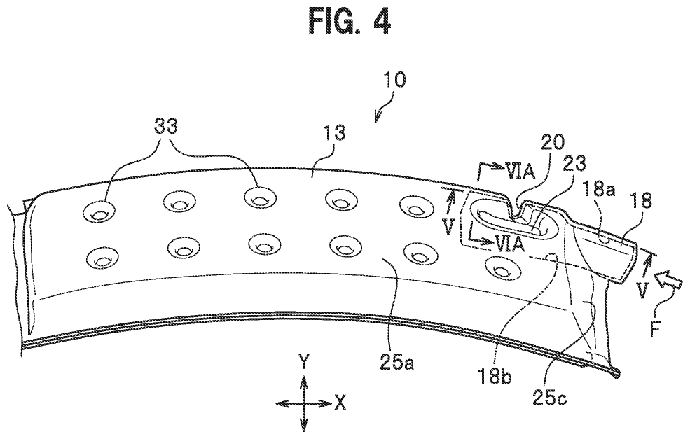

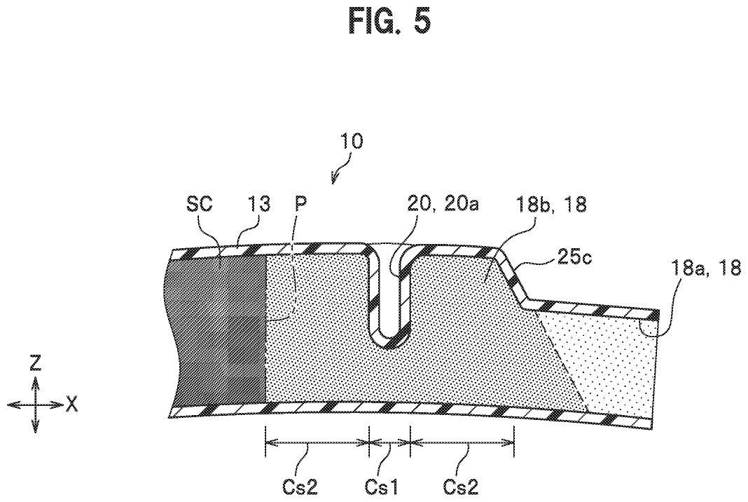

FIG. 4 is a partially enlarged perspective view of the resonator 10 as viewed from an arrow direction IV in FIG. 1. FIG. 5 is a cross-sectional view taken along a line V-V in FIG. 4.

As shown in FIG. 4, the communication hole 18 has an outer communication hole 18a extending outward from the lateral plate 25c in the circumferential direction X and an inner communication hole 18b extending inward from the lateral plate 25c in the circumferential direction X. Note that, in FIG. 4, a reference numeral 20 denotes a recess formed in the inner communication hole 18b, which is described in detail below.

The inner communication hole 18b is separated from the sub-air chamber SC (see FIG. 2), which is a hollow portion of the main body 13, by a hollow 23 formed in the main body 13 so as to extend in the circumferential direction X.

That is, as shown in FIG. 5, the communication hole 18 continues from the outer communication hole 18a through the lateral plate 25c to the inner communication hole 18b, and communicates with the sub-air chamber SC at a position P which is an edge of the hollow 23 (see FIG. 4).

Further, as shown in FIG. 5, the inner communication hole 18b (communication hole) has a first cross-sectional area Cs1 having a first channel cross-sectional area and second cross-sectional areas Cs2 each having a second channel cross-sectional area.

Note that the second cross-sectional area Cs2 in the present embodiment is a large-diameter section extending, with an inner diameter (normal diameter) in the radial direction of the communication hole 18 being substantially constant, in the circumferential direction. Further, the first cross-sectional area Cs1 in the present embodiment is a narrowed section defined by the recess 20 5 to be described below.

That is, the second channel cross-sectional area is a cross-sectional area perpendicular to the channel in the large-diameter section. The first channel cross-sectional area is a cross-sectional area perpendicular to the channel in the narrowed section.

The first cross-sectional area Cs1 is shorter in length along a channel direction for air than the second cross-sectional area Cs2. Further, the first cross-sectional area Cs1 has a channel cross-sectional area equal to or less than half of that of the second cross-sectional area Cs2.

Next, a description is given of the recess 20 (see FIG. 4).

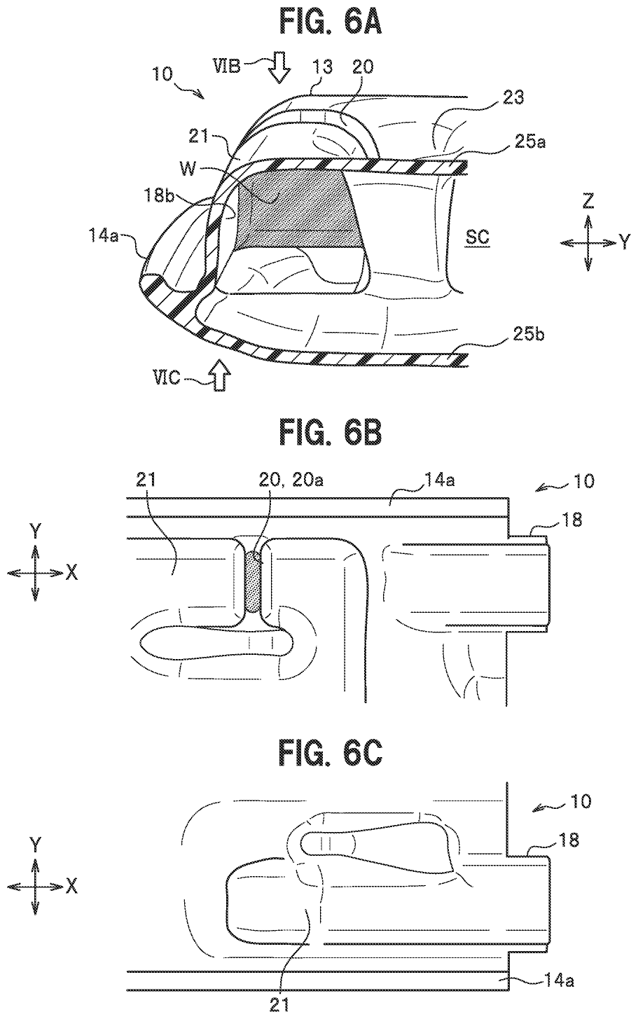

FIG. 6A is a partially enlarged perspective view of the resonator 10 including a cross section taken along a line VIA-VIA in FIG. 4. FIG. 6B is a partially enlarged plan view of the resonator 10 as viewed from an arrow direction VIB in FIG. 6A. FIG. 6C is a partially enlarged bottom view of the resonator 10 as viewed from an arrow direction VIC in FIG. 6A.

As shown in FIG. 6A, the recess 20 is formed to be recessed inward from an outside in the radial direction Z with respect to a tubular body 21 (communication hole forming part) defining the inner communication hole 18b.

However, as shown in FIG. 6C, the recess 20 is not formed in an inner side of the tubular body 21 (inner side in the radial direction Z in FIG. 6A (lower side of the drawing sheet of FIG. 6A)).

That is, as shown in FIG. 6A, the recess 20 is formed to be recessed inward (lower side of the drawing sheet of FIG. 6A) unidirectionally from the outside (upper side of the drawing sheet of FIG. 6A) in the radial direction Z, to intersect the channel direction (extending direction) of the inner communication hole 18b.

In other words, as shown in FIG. 6B, the recess 20 is formed by a groove 20a extending in the width direction Y to cross an upper side of the tubular body 21.

With this structure, as shown in FIG. 6A, a wall surface W is formed in the inner communication hole 18b, which extends inward from an outside in the radial direction Z and partially interrupts the inner communication hole 18b in an in-out direction.

Note that, in FIG. 6A, the reference numeral 23 denotes the hollow which separates the sub-air chamber SC from the inner communication hole 18b. The upper surface 25a is joined to the lower surface 25b of the main body 13 to form the hollow 23 having a cylindrical shape.

### Advantageous Effects

Next, a description is given of advantageous effects of the resonator 10 of the present embodiment and the vehicle wheel 1 provided with the same.

If a channel cross-sectional area of an entire communication hole is simply narrowed in a conventional Helmholtz resonator (see, Japanese Patent No. JP6541769, for example) to increase viscous resistance of the communication hole, this results in an increased difference between a desired value (set value) of the channel cross-sectional area and the channel cross-sectional area of the communication hole which is simply narrowed, caused by variation in thickness of the channel cross-sectional area. Accordingly, a resonance frequency of the Helmholtz resonator also varies greatly.

Meanwhile, in the present embodiment, the first cross-sectional area Cs1 having a larger change ratio in a channel cross-sectional area than the second cross-sectional areas Cs2 is partially formed in the channel. Therefore, the present embodiment has an advantageous effect over the case having a simply narrowed channel cross-sectional area throughout the entire communication hole 18, so that the difference between the channel cross-sectional area in design and the channel cross-sectional area of the molded product, caused by variation in thickness of a forming part of the communication hole 18, is reduced. Further, according to the present embodiment with the first cross-sectional area Cs1, the viscous resistance at the communication hole 18 is increased, to enhance an attenuation effect on resonance.

In the present embodiment, the first cross-sectional area Cs1, having a larger change ratio in a channel cross-sectional area than the second cross-sectional area Cs2, is set to be shorter in length along the channel direction than the second cross-sectional area Cs2.

According to the present embodiment described above, the difference in channel cross-sectional areas caused by variation in thickness is reduced than the case of having an entire channel cross-sectional area simply narrowed. Thus, the present embodiment allows for reducing variation in resonance frequency and preventing the resonance frequency from failing to be a set value.

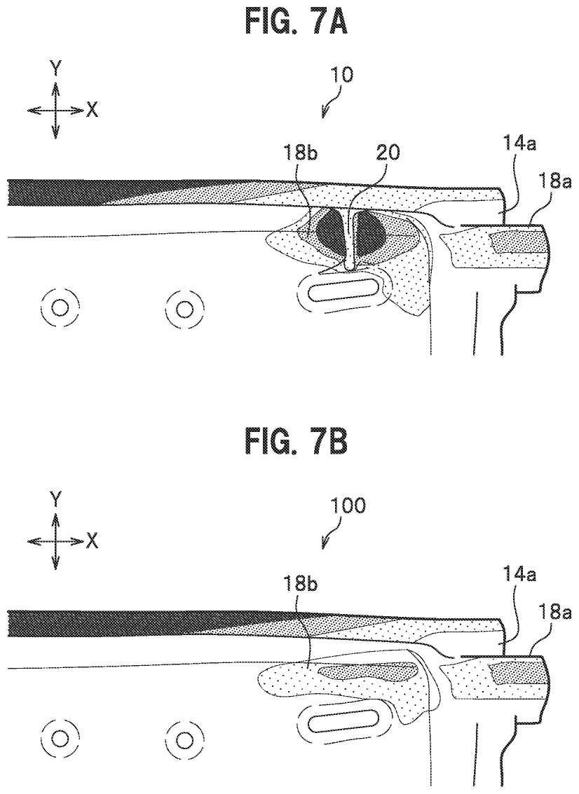

FIG. 7A is a displacement distribution diagram obtained by Computer Aided Engineering (CAE) when a centrifugal force is applied to the resonator 10 according to the present embodiment. FIG. 7B is a displacement distribution diagram obtained by CAE when the centrifugal force is applied to a Helmholtz resonator 100 according to a comparative example. The larger the displacement at a portion is, the darker the portion is shaded in FIGS. 7A and 7B.

As shown in FIG. 7B, in the Helmholtz resonator 100 of the comparative example in which the recess 20 is not formed in a communication forming part of the inner communication hole 18b, displacement is large over a long region at the edge 14a which has been locked in the groove 17a (see FIG. 2).

That is, the Helmholtz resonator 100 has the long region which is deformed greatly at the end in the circumferential direction X of the Helmholtz resonator 100, which is more likely separated from the well 11c (see FIG. 1) in the centrifugal direction.

Meanwhile, as shown in FIG. 7A, the present embodiment has the recess 20 in a communication hole forming part of the inner communication hole 18b.

In the embodiment described above, the first cross-sectional area Cs1 (see FIG. 5) in which the recess 20 has been formed has a larger mass factor than the second cross-sectional areas Cs2 (see FIG. 5) so that a larger centrifugal force is applied. Then, the first cross-sectional area Cs1 is displaced in the centrifugal direction prior to the second cross-sectional areas Cs2, and a force in a direction opposite to the centrifugal direction is applied to the edge 14a in the vicinity of the first cross-sectional area Cs1. That is, the force applied to the edge 14a is canceled to make the displacement smaller. The present embodiment described above prevents more reliably the resonator 10 from being separated from the well 11c.

In the present embodiment, the first cross-sectional area Cs1 is formed to have the recess 20 recessed in one direction which intersects the extending direction of the communication hole 18 (inner communication hole 18b).

Meanwhile, assuming that the recesses 20 are recessed in a plurality of directions to form the first cross-sectional area Cs1, for example, in order to secure air flow through the communication hole 18, it is not possible to recess the recesses 20 up to the middle of the channel.

In the present embodiment, the recess 20 is recessed unidirectionally so that the channel is interrupted at a position close to the middle of the channel. With this structure, the present embodiment interrupts the air flow, where the air flows fast at a position close to the middle of the channel, to further increase the viscous resistance in the communication hole 18. The present embodiment described above further enhances an attenuation effect on resonance.

In the present embodiment, the first cross-sectional area CS1 may be set to have a channel cross-sectional area equal to or less than half of that of the second cross-sectional area Cs2.

The present embodiment described above interrupts the middle of the channel at which air flows fastest in the communication hole 18, to further enhance an attenuation effect on resonance.

The present embodiment has been described above, but the present disclosure is not limited thereto and may be implemented in various configurations.

In the above embodiment (see FIGS. 6A to 6C), the recess 20 is recessed inward from the outside in the radial direction Z with respect to the tubular body 21 defining the inner communication hole 18b. That is, the recess 20 is formed by the groove 20a which extends in the width direction Y across an upper side of the tubular body 21.

However, the recess 20 formed in the communication hole forming part of the inner communication hole 18b is not limited thereto.

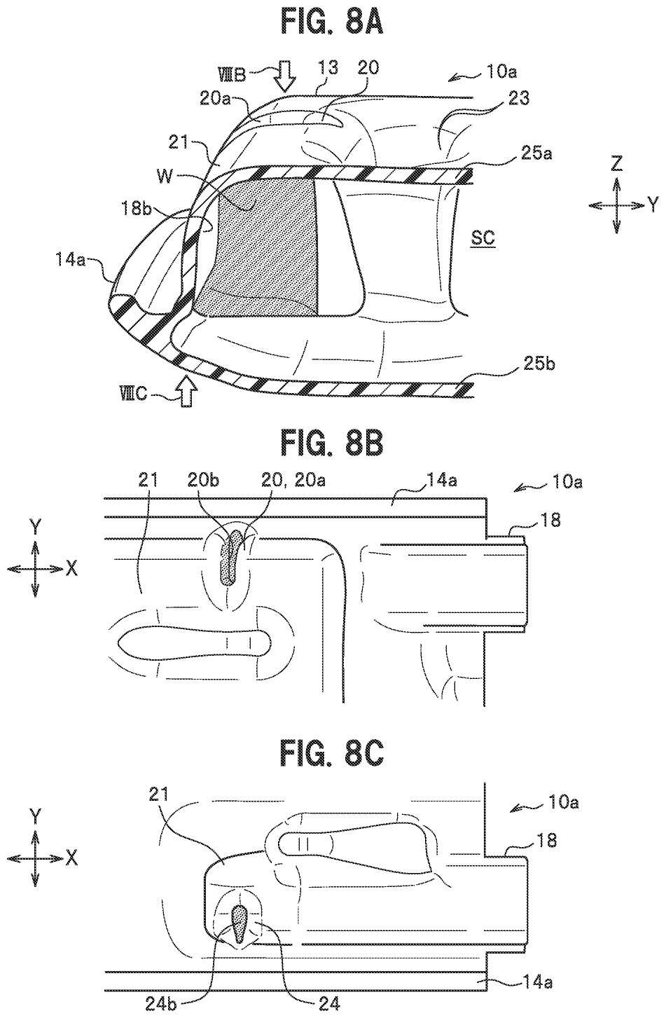

Next, FIG. 8A is a partially enlarged perspective view of a resonator 10a according to a first modification of the embodiment, which corresponds to FIG. 6A. FIG. 8B is a partially enlarged plan view of the resonator 10a as viewed from an arrow direction VIIIB in FIG. 8A. FIG. 8C is a partially enlarged bottom view of the resonator 10a as viewed from an arrow direction VIIIC in FIG. 8A.

Note that, in FIGS. 8A to 8C, the same components as those of the embodiment described above (see FIGS. 6A to 6C) are denoted by the same reference symbols, and detailed descriptions thereof are omitted.

As shown in FIG. 8A, the recess 20 in the first modification is formed such that the tubular body 21 is recessed in a direction from one edge 14a closer to the inner communication hole 18b toward the other edge 14b (see FIG. 2).

That is, the recess 20 is formed of the groove 20a extending from an upper side (outer side in the radial direction) toward an inner side (inner side in the radial direction) of the tubular body 21.

Then, as shown in FIG. 8B, the recess 20 has a bottom 20b as a dead end in the radial direction Z (direction normal to a plane of the drawing paper of FIG. 8B) of the groove 20a.

The bottom 20b is positioned substantially as high as the lower surface 25b (see FIG. 8A) of the main body 13 (see FIG. 8A).

As shown in FIG. 8C, a recess 24 is formed in the inner side (inner side in the radial direction Z) of the tubular body 21 at a position corresponding to the recess 20 (see FIG. 8A).

Note that a bottom 24b of the recess 24 is the same as the bottom 20b (see FIG. 8A) of the recess 20 (see FIG. 8A).

As shown in FIG. 8A, the resonator 10a according to the first modification described above includes the wall surface W which extends inward (right side of FIG. 8A) from the outside (left side of FIG. 8A) in the width direction Y to partially interrupt the inner communication hole 18b.

According to the resonator 10a of the first modification, the edge 14a (see FIGS. 8B and 8C) in the vicinity of the recess 20 (see FIG. 8B) and the recess 24 (see FIG. 8C) is applied with a force in a direction opposite to the centrifugal direction. That is, the force applied to the edge 14a is canceled to make the displacement smaller. The present embodiment described above more reliably prevents the resonator 10 from being separated from the well 11c (see FIG. 2).

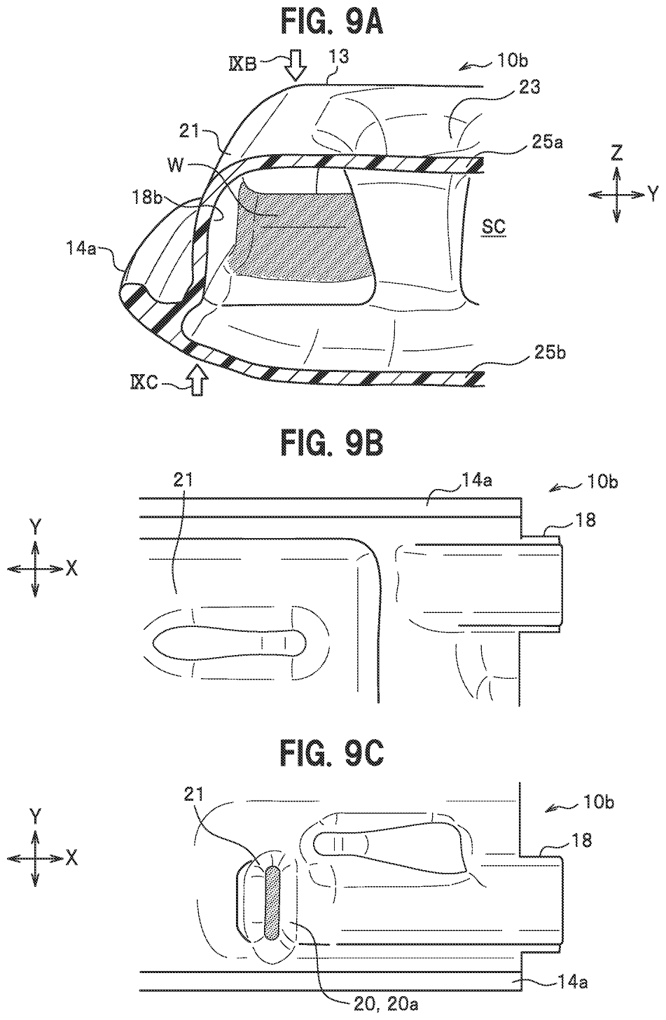

Next, FIG. 9A is a partially enlarged perspective view of a resonator 10b according to a second modification of the embodiment, which corresponds to FIG. 6A. FIG. 9B is a partially enlarged plan view of the resonator 10b as viewed from an arrow direction IXB in FIG. 9A. FIG. 9C is a partially enlarged bottom view of the resonator 10b as viewed from an arrow direction IXC in FIG. 9A.

Note that, in FIGS. 9A to 9C, the same components as those of the embodiment described above (see FIGS. 6A to 6C) are denoted by the same reference symbols, and detailed descriptions thereof are omitted.

As shown in FIGS. 9A, 9B and 9C, the recess 20 of the resonator 10b according to the second modification, which is different from the recess 20 in the embodiment shown in FIG. 6A, is recessed outward from an inner side in the radial direction Z with respect to the tubular body 21 defining the inner communication hole 18b.

The resonator 10b according to the second modification described above also exhibits the same effects as the embodiment described above (see FIGS. 6A to 6C).

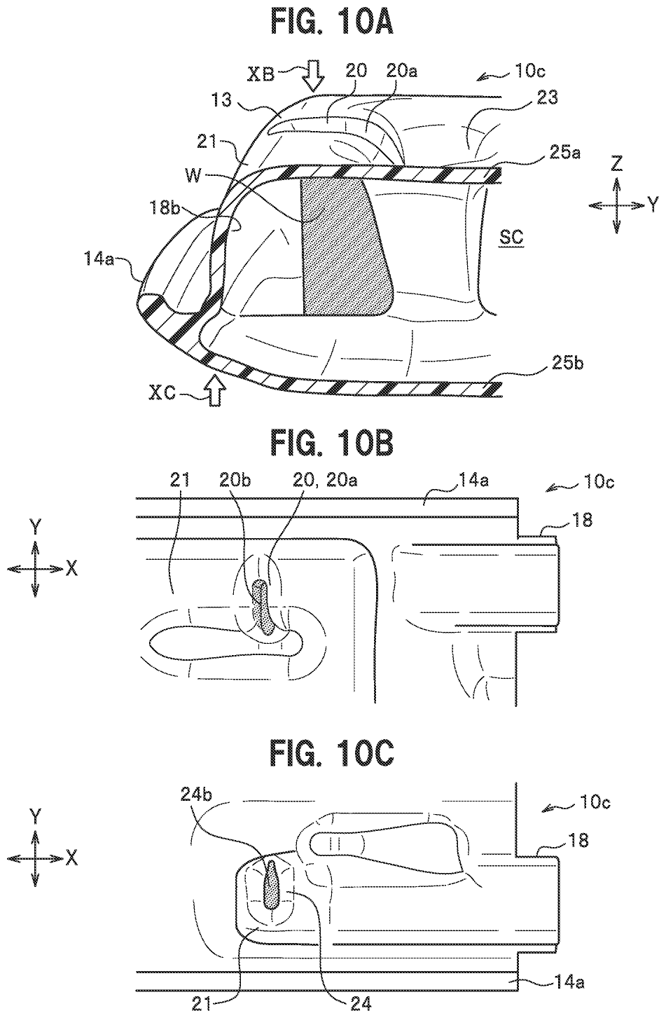

Next, FIG. 10A is a partially enlarged perspective view of a resonator 10c according to a third modification of the embodiment, which corresponds to FIG. 8A. FIG. 10B is a partially enlarged plan view of the resonator 10c as viewed from an arrow direction XB in FIG. 10A. FIG. 10C is a partially enlarged bottom view of the resonator 10c as viewed from an arrow direction XC in FIG. 10A.

Note that, in FIGS. 10A to 10C, the same components as those of the first modification described above (see FIGS. 8A to 8C) are denoted by the same reference symbols, and detailed descriptions thereof are omitted.

As shown in FIGS. 10A, 10B and 10C, the recesses 20 and 24 of the resonator 10c according to the third modification, which is different from the recesses 20 and 24 in the first modification shown in FIG. 8A, are formed such that the tubular body 21 is recessed in a direction from the edge 14b (see FIG. 2) toward the edge 14a (see FIG. 2).

The resonator 10c of the third modification described above also exhibits the same effects as the first modification (see FIGS. 8A to 8C).

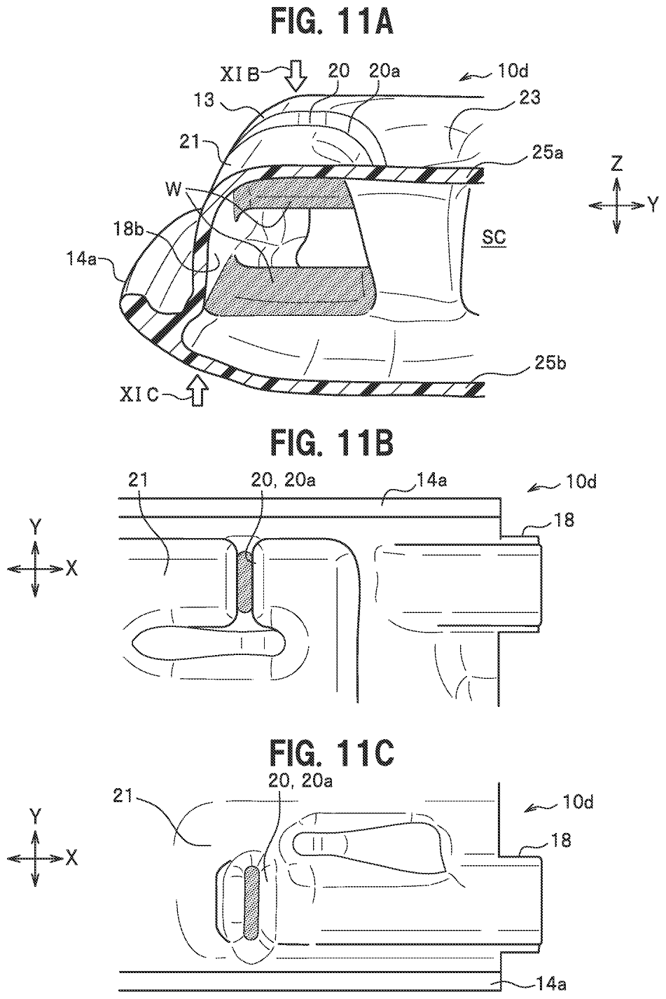

Next, FIG. 11A is a partially enlarged perspective view of a resonator 10d according to a fourth modification of the embodiment, which corresponds to FIG. 6A. FIG. 11B is a partially enlarged plan view of the resonator 10d as viewed from an arrow direction XIB in FIG. 11A. FIG. 11C is a partially enlarged bottom view of the resonator 10d as viewed from an arrow direction XIC in FIG. 11A.

Note that, in FIGS. 11A to 11C, the same components as those of the embodiment (see FIGS. 6A to 6C) are denoted by the same reference symbols, and detailed descriptions thereof are omitted.

As shown in FIGS. 11A, 11B, and 11C, the recess 20 of the resonator 10d according to the fourth modification, which is different from that in the embodiment shown in FIG. 6A, is recessed in two directions, that is, inward from the outer side and further outward from the inner side in the radial direction Z, with respect to the tubular body 21 defining the inner communication hole 18b.

That is, the resonator 10d according to the fourth modification has the wall surface W (see FIG. 6A) of the embodiment above and the wall surface W (see FIG. 9A) of the second modification.

The resonator 10d according to the fourth modification also exhibits the same effects as the embodiment (see FIGS. 6A to 6C).

Further, according to the resonator 10d according to the fourth modification, the channel is interrupted by the short wall surfaces W extending in two directions, as compared with the case having a long wall surface W extending in one direction. With the resonator 10d described above, the recess 20 forming the wall surface W is easily formed by die-cutting.

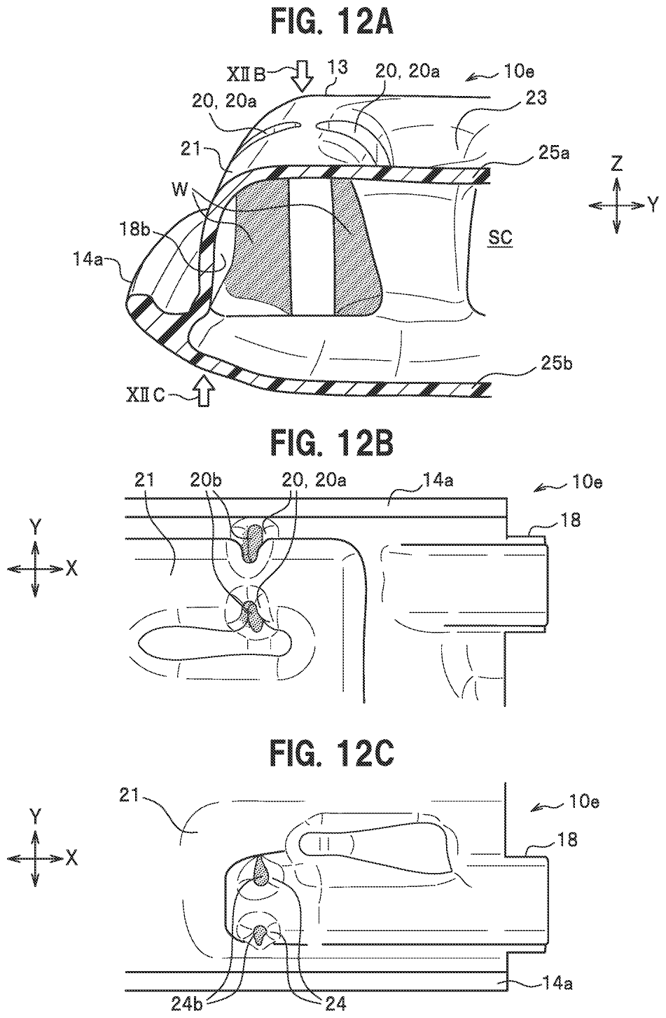

Next, FIG. 12A is a partially enlarged perspective view of a resonator 10e according to a fifth modification of the embodiment, which corresponds to FIG. 8A. FIG. 12B is a partially enlarged plan view of the resonator 10e as viewed from an arrow direction XIIB in FIG. 12A. FIG. 12C is a partially enlarged bottom view of the resonator 10e as viewed from an arrow direction XIIC in FIG. 12A.

Note that, in FIGS. 12A to 12C, the same components as those in the embodiment (see FIGS. 8A to 8C) above are denoted by the same reference symbols, and detailed descriptions thereof are omitted.

As shown in FIGS. 12A, 12B, and 12C, the recesses 20 and 24 of the resonator 10e according to the fifth modification, which are different from those in the first modification shown in FIGS. 8A and 8C, are formed to be recessed in two directions, that is, from the edge 14a (see FIG. 2) toward the edge 14b (see FIG. 2) and further from the edge 14b (see FIG. 2) toward the edge 14a (see FIG. 2), with respect to the tubular body 21 defining the inner communication hole 18b.

That is, the resonator 10e according to the fifth modification has the wall surface W (see FIG. 8A) of the first modification and the wall surface W (see FIG. 10A) of the third modification.

The resonator 10e according to the fifth modification also exhibits the same effects as the first modification (see FIGS. 8A to 8C) above.

Further, in the embodiment (see FIGS. 6A to 6C), the resonator 10 has been described in which the recess 20 is formed in the communication hole forming part of the inner communication hole 18b, but the recess 20 may be formed in the communication hole forming part of the outer communication hole 18a.

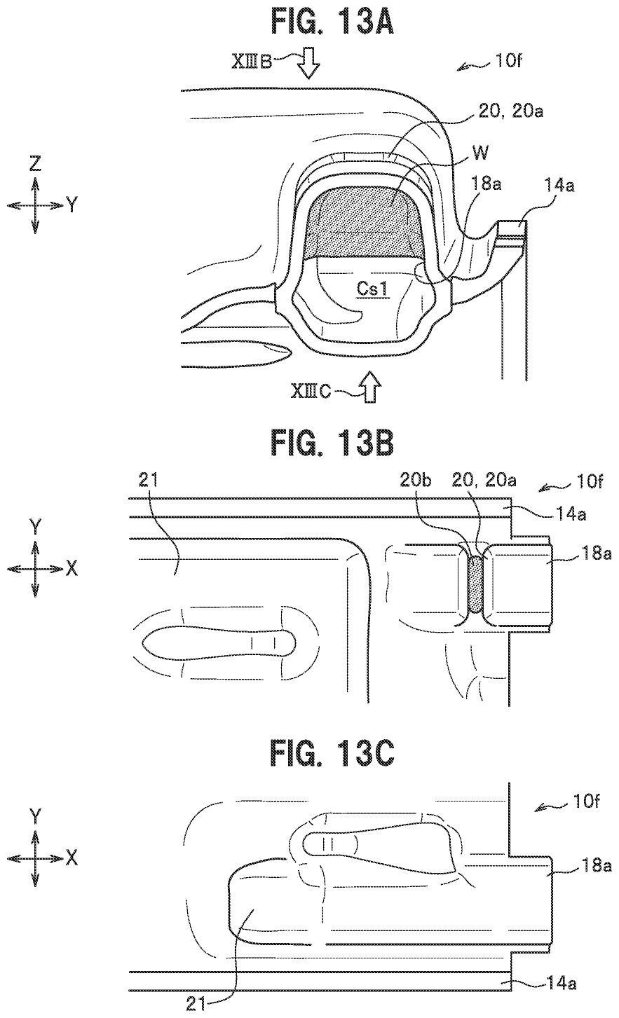

Next, FIG. 13A is a partially enlarged perspective view of a resonator 10f according to a sixth modification of the embodiment, as viewed from a direction corresponding to the arrow direction F in FIG. 4. FIG. 13B is a partially enlarged plan view of the resonator 10f as viewed from an arrow direction XIIIB in FIG. 13A. FIG. 13C is a partially enlarged bottom view of the resonator 10f as viewed from an arrow direction XIIC in FIG. 13A. In FIG. 13A, the reference symbol Cs1 denotes the first cross-sectional area.

Note that, in FIGS. 13A to 13C, the same components as those in the embodiment (see FIGS. 6A to 6C) are denoted by the same reference symbols, and detailed descriptions thereof are omitted.

As shown in FIGS. 13A, 13B, and 13C, the resonator 10f according to the sixth modification is the same as the embodiment (see FIGS. 6A, 6B, and 6C) including the recess 20 formed in the communication hole forming part of the inner communication hole 18b, except that the recess 20 is formed in the communication hole forming part of the outer communication hole 18a.

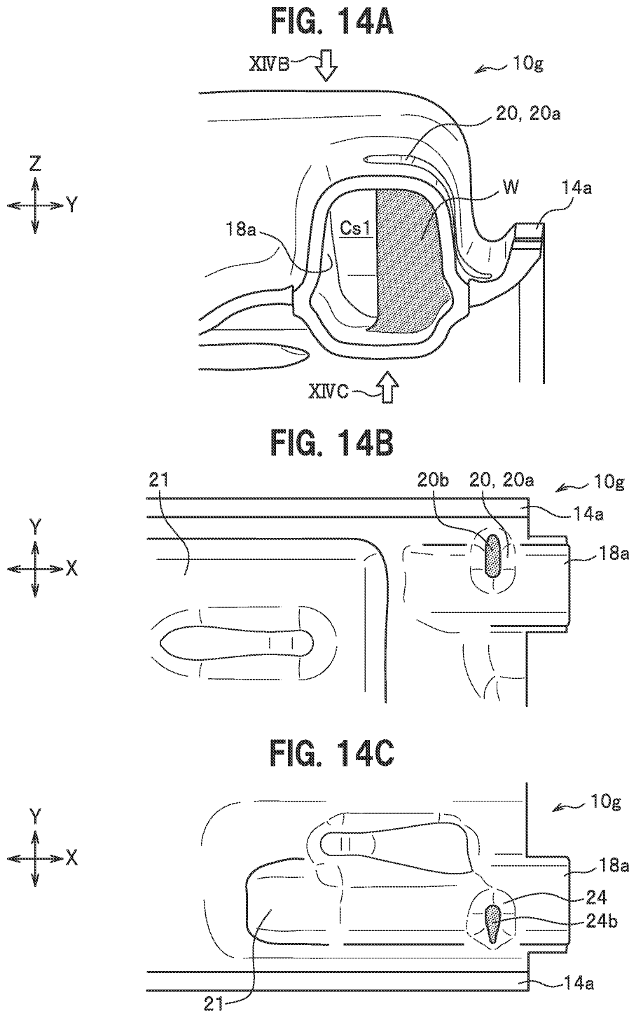

Next, FIG. 14A is a partially enlarged perspective view of a resonator 10g according to a seventh modification of the embodiment, as viewed from the arrow direction F in FIG. 4. FIG. 14B is a partially enlarged plan view of the resonator 10g as viewed from an arrow direction XIVB in FIG. 14A. FIG. 14C is a partially enlarged bottom view of the resonator 10g as viewed from an arrow direction XIVC in FIG. 14A. In FIG. 14A, the reference symbol Cs1 denotes the first cross-sectional area.

Note that, in FIGS. 14A to 14C, the same components as those in the embodiment (see FIGS. 8A to 8C) are denoted by the same reference symbols, and detailed descriptions thereof are omitted.

As shown in FIGS. 14A, 14B, and 14C, the resonator 10g according to the seventh modification is the same as the first modification (see FIGS. 8A, 8B, and 8C) including the recesses 20, 24 formed in the communication hole forming part of the inner communication hole 18b, except that the recesses 20, 24 are formed in the communication hole forming part of the outer communication hole 18a.

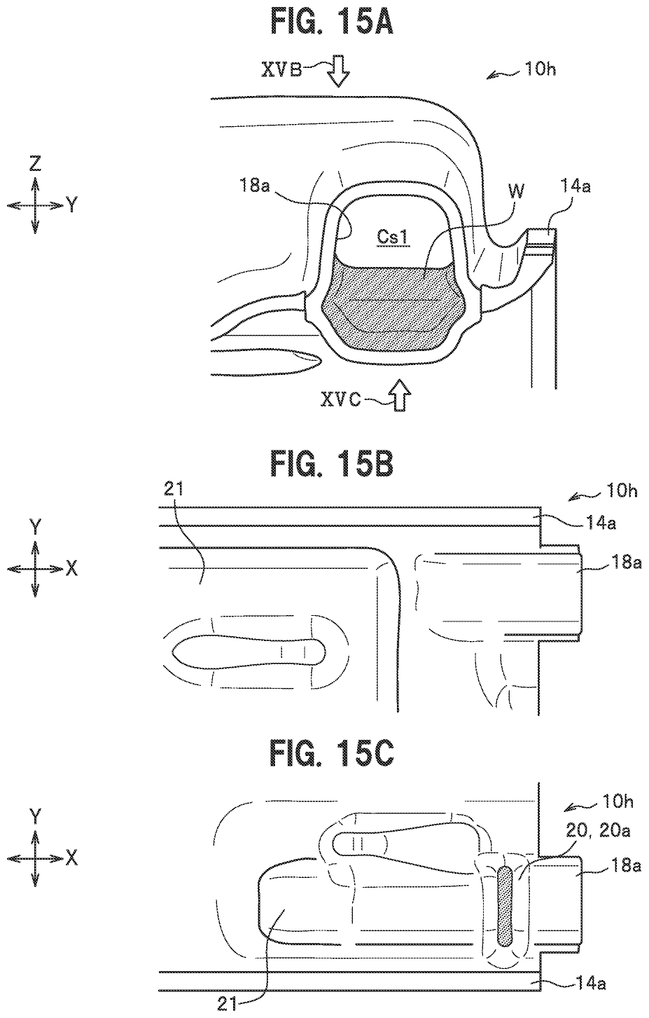

Next, FIG. 15A is a partially enlarged perspective view of a resonator 10h according to an eighth modification of the embodiment, as viewed from the arrow direction F in FIG. 4. FIG. 15B is a partially enlarged plan view of the resonator 10h as viewed from an arrow direction XVB in FIG. 15A. FIG. 15C is a partially enlarged bottom view of the resonator 10h as viewed from an arrow direction XVC in FIG. 15A. In FIG. 15A, the reference symbol Cs1 denotes the first cross-sectional area.

Note that, in FIGS. 15A to 15C, the same components as those in the second modification (see FIGS. 9A to 9C) are denoted by the same reference symbols, and detailed descriptions thereof are omitted.

As shown in FIGS. 15A, 15B, and 15C, the resonator 10h according to the eighth modification is the same as the second modification (see FIGS. 9A, 9B, and 9C) including the recess 20 formed in the communication hole forming part of the inner communication hole 18b, except that the recess 20 is formed in the communication hole forming part of the outer communication hole 18a.

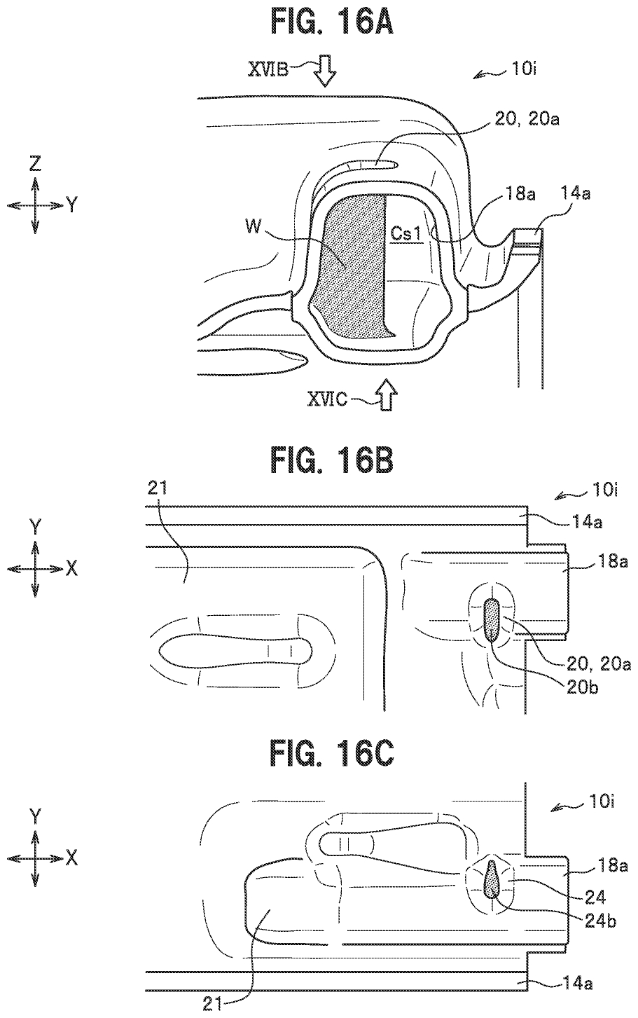

Next, FIG. 16A is a partially enlarged perspective view of a resonator 10i according to a ninth modification of the embodiment, as viewed from the arrow direction F in FIG. 4. FIG. 16B is a partially enlarged plan view of the resonator 10i as viewed from an arrow direction XVIB in FIG. 16A. FIG. 16C is a partially enlarged bottom view of the resonator 10i as viewed from an arrow direction XVIC in FIG. 16A. In FIG. 16A, the reference symbol Cs1 denotes the first cross-sectional area.

Note that, in FIGS. 16A to 16C, the same components as those in the third modification (see FIGS. 10A to 10C) are denoted by the same reference symbols, and detailed descriptions thereof are omitted.

As shown in FIGS. 16A, 16B, and 16C, the resonator 10i according to the ninth modification is the same as the third modification (see FIGS. 10A, 10B, and 10C) including the recesses 20, 24 formed in the communication hole forming part of the inner communication hole 18b, except that the recesses 20, 24 are formed in the communication hole forming part of the outer communication hole 18a.

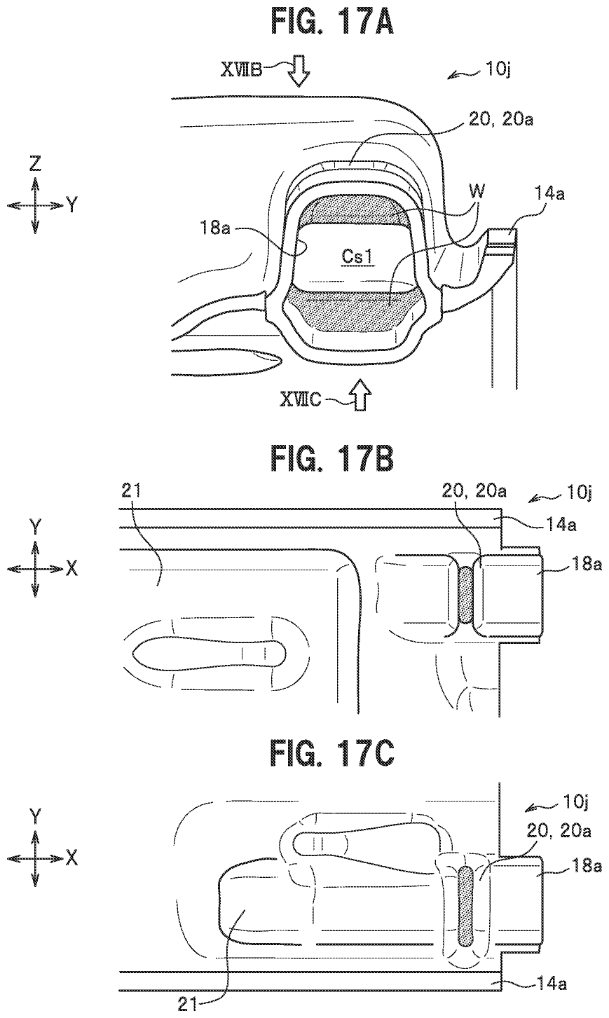

Next, FIG. 17A is a partially enlarged perspective view of a resonator 10j according to a tenth modification of the embodiment, as viewed from the arrow direction F in FIG. 4. FIG. 17B is a partially enlarged plan view of the resonator 10j as viewed from an arrow direction XVIIB in FIG. 17A. FIG. 17C is a partially enlarged bottom view of the resonator 10j as viewed from an arrow direction XVIIC in FIG. 17A. In FIG. 17A, the reference symbol Cs1 denotes the first cross-sectional area.

Note that, in FIGS. 17A to 17C, the same components as those in the fourth modification (see FIGS. 11A to 11C) are denoted by the same reference symbols, and detailed descriptions thereof are omitted.

As shown in FIGS. 17A, 17B, and 17C, the resonator 10j according to the tenth modification is the same as the fourth modification (see 11A, 11B, and 11C) including the recess 20 formed in the communication hole forming part of the inner communication hole 18b, except that the recess 20 is formed in the communication forming part of the outer communication hole 18a.

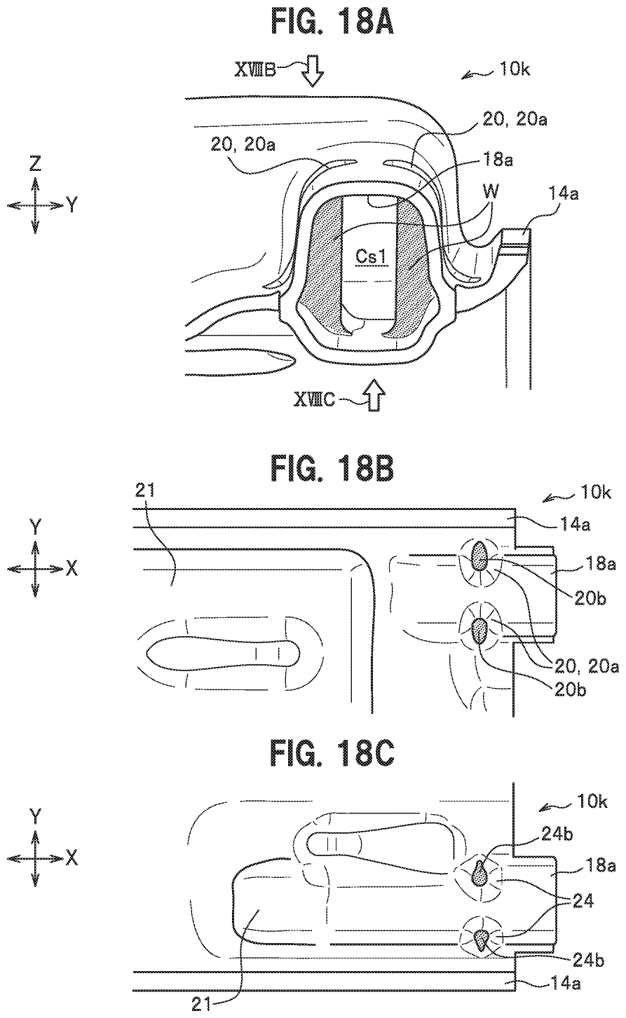

Next, FIG. 18A is a partially enlarged perspective view of a resonator 10k according to an eleventh modification of the embodiment, as viewed from the arrow direction F in FIG. 4. FIG. 18B is a partially enlarged plan view of the resonator 10k as viewed from an arrow direction XVIIIB in FIG. 18A. FIG. 18C is a partially enlarged bottom view of the resonator 10k as viewed from an arrow direction XVIIIC in FIG. 18A. In FIG. 18A, the reference symbol Cs1 denotes the first cross-sectional area.

Note that, in FIGS. 18A to 18C, the same components as those in the fifth modification (see FIGS. 12A to 12C) are denoted by the same reference symbols, and detailed descriptions thereof are omitted.

As shown in FIGS. 18A, 18B, and 18C, the resonator 10k according to the eleventh modification is the same as the fifth modification (see FIGS. 12A, 12B, and 12C) including the recesses 20, 24 formed in the communication hole forming part of the inner communication hole 18b, except that the recesses 20, 24 are formed in the communication hole forming part of the outer communication hole 18a.

As described above, the resonator 10f of the sixth modification (FIG. 13A) to the resonator 10k of the eleventh modification (FIG. 18A) include the recesses 20, formed in the communication hole forming part of the outer communication hole 18a.

In the sixth to eleventh modifications, as described above, when air is blown by blow molding into the mold to form the forming part of the communication hole 18, the first cross-sectional area Cs1 is defined in the vicinity of an air inlet where molding can be executed with high dimensional accuracy. This further reduces variation in channel cross-sectional area in the sixth to eleventh modifications.

Further, in the above embodiment, as shown in FIG. 5, the single first cross-sectional area Cs1 is assumed to be provided in the channel direction in the communication hole 18, but the present disclosure is not limited thereto and a plurality of first cross-sectional areas Cs1 may be provided.

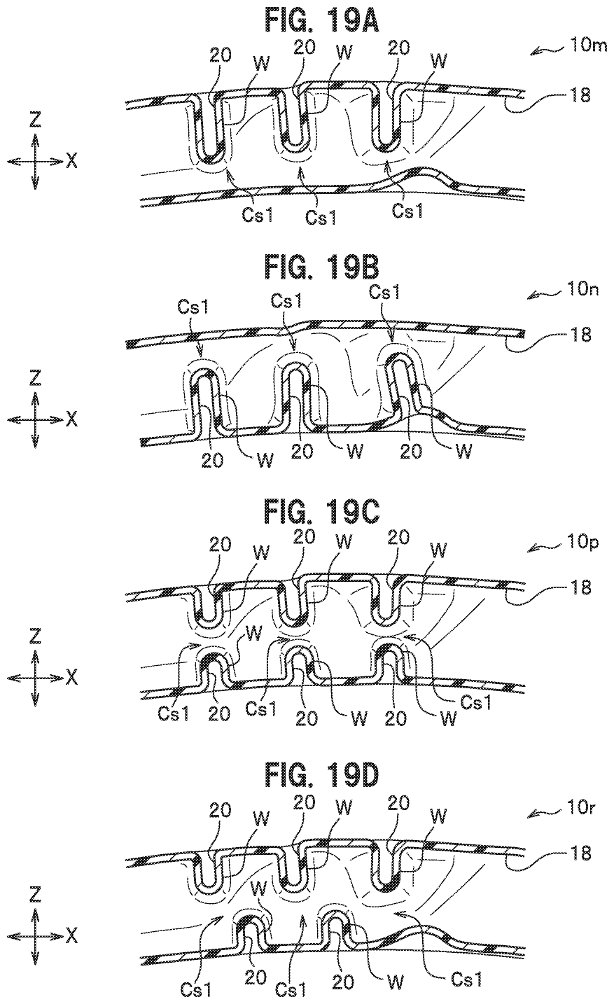

FIG. 19A is a lateral cross-sectional view of the communication hole 18 along the circumferential direction X of a resonator 10m according to a twelfth modification. FIG. 19B is a lateral cross-sectional view of the communication hole 18 along the circumferential direction X of a resonator 10n according to a thirteenth modification. FIG. 19C is a lateral cross-sectional view of the communication hole 18 along the circumferential direction X of a resonator 10p according to a fourteenth modification. FIG. 19D is a lateral cross-sectional view of the communication hole 18 along the circumferential direction X of a resonator 10r according to a fifteenth modification.

As shown in FIG. 19A, the resonator 10m of the twelfth modification is formed with the recesses 20 recessed inward from the outer side in the radial direction Z so that a plurality of wall surfaces W are formed in line along the circumferential direction X. Accordingly, a plurality of first cross-sectional areas Cs1 are provided in the communication hole 18 in line along the circumferential direction X.

As shown in FIG. 19B, the resonator 10n of the thirteenth modification is formed with the recesses 20 recessed outward from the inside in the radial direction Z so that a plurality of wall surfaces W are formed to be arranged in the circumferential direction X. Accordingly, a plurality of first cross-sectional areas Cs1 are defined in the communication hole 18 to be arranged in the circumferential direction X.

As shown in FIG. 19C, the resonator 10p of the fourteenth modification is formed with the recesses 20 inward from the outer side in the radial direction Z, and additionally with the recesses 20 recessed outward from the inner side in the radial direction Z so as to face the recesses 20 recessed inward. Accordingly, a plurality of wall surfaces W are formed in line along the circumferential direction X, and a plurality of first cross-sectional areas Cs1 are provided in the communication hole 18.

As shown in FIG. 19D, the resonator 10r of the fifteenth modification is formed with the recesses 20 recessed inward from the outer side in the radial direction Z, and additionally with the recesses 20 recessed outward from the inner side so as to be alternately lined with the recesses 20 recessed inward in the radial direction Z. Accordingly, a plurality of wall surfaces W are formed in line along the circumferential direction X, and a plurality of first cross-sectional areas Cs1 are provided in the communication hole 18.

In the twelfth to fifteenth modifications as described above, the first cross-sectional areas Cs1 are provided along the circumferential direction X in the communication hole 18, so that air flow caused by sound pressure changes is suppressed during resonance at a plurality of locations. Accordingly, viscous resistance in the communication hole 18 is increased to enhance an attenuation effect on resonance.

Further, in the twelfth to fifteenth modifications described above, a number of wall surfaces W are provided to allow each to have a lower height than a single wall surface arranged to obtain the same viscous resistance as these modifications. Accordingly, in the twelfth to fifteenth modifications, the wall surfaces W each can have a height with high dimensional accuracy. For this reason, in the twelfth to fifteenth modifications, variation in resonance frequency among mass-produced resonators are reduced and the resonance frequency is prevented from failing to be a desired resonance frequency (set value).

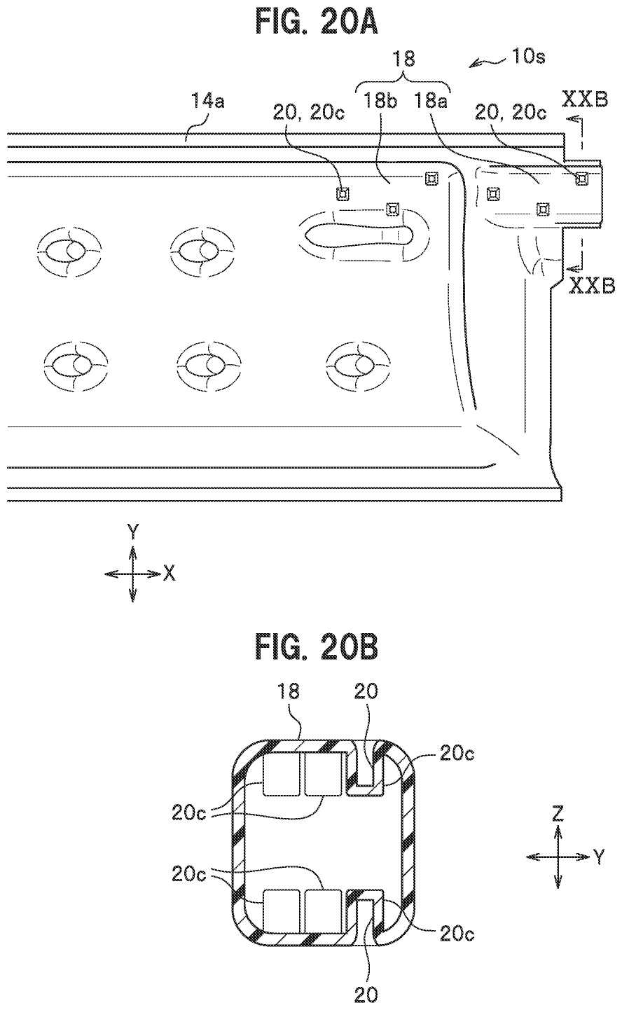

FIG. 20A is a partially enlarged plan view in the vicinity of the communication hole 18 of a resonator 10s according to a sixteenth modification. FIG. 20B is a cross-sectional view taken along a line XXB-XXB in FIG. 20A.

As shown in FIGS. 20A and 20B, the recesses 20 of the resonator 10s are formed to be recessed, in a square cylindrical shape, inward from the outer side and additionally outward from the inner side in the radial direction Z.

As shown in FIG. 20B, the recesses 20 define protrusions 20c in the communication hole 18.

The protrusions 20c are provided over the outer communication hole 18a and the inner communication hole 18b.

The protrusions 20c in the sixteenth modification are assumed to be randomly arranged between the outer communication hole 18a and the inner communication hole 18b, but may be arranged in line along the circumferential direction X or the width direction Y.

Further, the protrusions 20c may be formed in either the outer communication hole 18a or the inner communication hole 18b. Still further, the protrusions 20c may be provided on either the outer side or the inner side in the radial direction Z. Yet further, the protrusions 20c may be provided on either one or both sides in the width direction Y of the inner wall of the communication hole 18.

As shown in FIG. 2, in the above embodiment, the lower surface 25b of the resonator 10 is assumed to be flat along the width direction Y, but the present disclosure is not limited thereto.

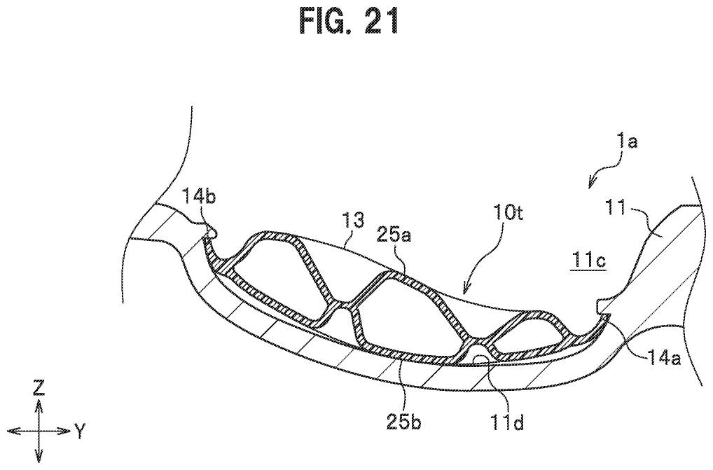

FIG. 21 is a cross-sectional view of a vehicle wheel 1a including a resonator 10t of a seventeenth modification, which corresponds to FIG. 2 of the embodiment.

As shown in FIG. 21, the outer circumferential surface 11d of the well 11c is curved to be recessed outward in the radial direction Z. The lower surface 25b of the resonator 10t is curved to protrude inward in the radial direction Z so as to follow the outer circumferential surface 11d.

Note that, in FIG. 21, the reference numeral 11 denotes the rim, the reference numeral 13 denotes the main body, and the reference numerals 14a and 14b denote the edges. The reference numeral 25a denotes the upper surface.

What is claimed is:

1. A vehicle wheel resonator comprising:
a resonator main body which is mounted on a vehicle wheel in a tire air chamber between the vehicle wheel and a tire, to define a sub-air chamber; and
a communication hole through which the sub-air chamber communicates with the tire air chamber,
wherein the communication hole has a first cross-sectional area having a first channel cross-sectional area and a second cross-sectional area having a second channel cross-sectional area, and
the first channel cross-sectional area is smaller than the second channel cross-sectional area.

2. The vehicle wheel resonator as claimed in claim 1, wherein the first cross-sectional area is shorter in length along a channel direction than the second cross-sectional area in the communication hole.

3. The vehicle wheel resonator as claimed in claim 1,
wherein the resonator main body is mounted on an outer circumferential surface of a well of the vehicle wheel, and has a lower surface arranged on an outer circumferential surface of the well, an upper surface arranged on an outer side in a radial direction of the vehicle wheel than the lower surface, and two edges which connect the upper surface with the lower surface and engage with the well,
the two edges are formed at both ends, in a width direction of the vehicle wheel, of the resonator main body,
the well has a plurality of vertical walls vertically arranged on the outer circumferential surface and extending in a circumferential direction of the vehicle wheel,
the vertical walls have a first vertical wall surface formed with a first groove extending in the circumferential direction and a second vertical wall surface facing the first vertical wall surface in the width direction and formed with a second groove,
the two edges are fitted into the first groove and the second groove, respectively,
the communication hole is formed at an end in the circumferential direction of the resonator main body and at one end in the width direction, and is open in the circumference direction, and
the first cross-sectional area is formed to have a recess recessed inward from an outer side in the radial direction with respect to the communication hole and along the width direction.

4. The vehicle wheel resonator as claimed in claim 1,
wherein the resonator main body is mounted on an outer circumferential surface of a well of the vehicle wheel, and has a lower surface arranged on an outer circumferential surface of the well, an upper surface arranged on an outer side in a radial direction of the vehicle wheel than the lower surface, and two edges which connect the upper surface with the lower surface and engage with the well,
the two edges are formed at both ends, in a width direction of the vehicle wheel, of the resonator main body,
the well has vertically a plurality of vertical walls arranged on the outer circumferential surface and extending in a circumferential direction of the vehicle wheel,
the vertical walls have a first vertical wall surface formed with a first groove extending in the circumferential direction and a second vertical wall surface facing the first vertical wall surface in the width direction and formed with a second groove,
the two edges are fitted into the first groove and the second groove, respectively,
the communication hole is formed at an end in the circumferential direction of the resonator main body and at one end in the width direction, and is open in the circumference direction, and
the first cross-sectional area is formed to have a recess in a direction from one edge closer to the communication hole toward the other edge.

5. The vehicle wheel resonator as claimed in claim 1, wherein a plurality of the first cross-sectional areas are provided in a channel direction of the communication hole.

6. The vehicle wheel resonator as claimed in claim 1,
wherein the communication hole has an inner communication hole to communicate with the sub-air chamber in the width direction and an outer communication hole extending in the circumferential direction from the inner communication hole,
the first cross-sectional area is provided in the outer communication hole, and
the resonator is formed by blow molding in which air is blown through the communication hole.

7. The vehicle wheel as claimed in claim 1, wherein the first cross-sectional area is defined by a recess recessed from one direction intersecting with an extending direction of the communication hole.

8. The vehicle wheel resonator as claimed in claim 7, wherein the channel cross-sectional area of the first cross-sectional area is equal to or less than half of that of a channel cross-sectional area of the second cross-sectional area.

9. A vehicle wheel comprising the vehicle wheel resonator as claimed in claim 1.

10. A vehicle wheel comprising the vehicle wheel resonator as claimed in claim 7.
